(19) United States
(12) Patent Application Publication
(10) Pub. No.: US 2005/0122404 A1
(43) Pub. Date: Jun. 9, 2005

(54) [PORTABLE COMMUNICATION DEVICE]

(76) Inventor: REN-HAO LIU, TAIPEI CITY (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/708,226

(22) Filed: Feb. 18, 2004

(30) Foreign Application Priority Data
Dec. 4, 2003 (TW) 92134143

(51) Int. Cl. G06K 7/10

(52) U.S. Cl. 348/211.2

(57) ABSTRACT

A portable communication device comprising a casing, a host module, a wireless communication module, an image-capturing unit, a man-machine interface, an acoustic-controlled camera module and a voice-input unit is provided. The host module is set inside the casing. The wireless communication module and the acoustic-controlled camera module are set inside the casing and are electrically coupled to the host module. The wireless communication module is used to receive/transmit a communication signal. The acoustic-controlled cameral module is used to control the image-capturing unit. The image-capturing unit and the man-machine interface are mounted on the casing and are electrically coupled to the host module. The image-capturing unit is used to capture an optical image of an object. The man-machine interface is used to control the host module. The voice-input unit is mounted on the casing and electrically connected to the acoustic-controlled camera module for receiving a voice message.

### BACKGROUND OF INVENTION

1. Field of the Invention

The present invention relates to a portable communication device. More particularly, the present invention relates to a portable communication device with an acoustic-controlled camera.

2. Description of the Related Art

In this information explosion era, electronic communication has become indispensable. People rely heavily on electronic devices to transmit messages. With the invention of portable devices such as cellular phone or other wireless communication devices, portable communication is even more popular.

As innovative manufacturing techniques continue to be discovered, additional functions are added to a cellular phone. Aside from receiving signals, many types of cellular phone are now provided with a camera. Through a wireless communication service system, a user may capture a digital image of a particular object or scenery using a cellular phone and then transmit the image to another person. In this way, users may capture images and transmit the images to remote users through their cellular phones.

Although most conventional cellular phone has a camera, however when a user wish to operate the button of the cellular phone camera for taking a group picture including himself/herself or taking a picture of himself/herself is often limited due the button-activated setup of the cellular phone. In other words, the cellular phone camera can be at most positioned at an arm's length while taking a picture of himself/herself. With the limited distance between the target object(s) and the cellular phone camera, the captured image of the target object(s) is likely to be distorted. When the camera is inconvenient to use and produces distorted images, the desire for purchasing a cellular phone with image capturing functionality may be not be attractive to the consumers. Therefore, it is highly desirable to overcome the above defects of the conventional cellular phone with image capturing functionality and improve the quality of images captured by a cellular phone with image capturing functionality in order to stimulate consumers' desire for purchasing the cellular phone with improved image capturing functionality features.

### SUMMARY OF INVENTION

Accordingly, at least one objective of the present invention is to provide a portable communication device with image capturing functionality having acoustic-controlled activation features to remotely control the image capturing functions.

To achieve these and other advantages and in accordance with the purpose of the invention, as embodied and broadly described herein, the invention provides a portable communication device. The portable communication device comprises a casing, a host module, a wireless communication module, an image-capturing unit, a man-machine interface, an acoustic-controlled camera module and a voice-input unit. The host module is set inside the casing. The wireless communication module and the acoustic-controlled camera module are set inside the casing and electrically coupled to the host module. The wireless communication module is used to receive/transmit a communication signal. The acoustic-controlled cameral module is used to control the image-capturing unit. The image-capturing unit and the man-machine interface are mounted on the casing and are electrically coupled to the host module. The image-capturing unit is used to capture an optical image of an object. The man-machine interface is used to control the host module. The voice-input unit is mounted on the casing and is electrically connected to the acoustic-controlled camera module for receiving a voice message.

According to one embodiment of the present invention, the portable communication device further comprises a first connecting port mounted on the casing and electrically connected to the host module and the image-capturing unit has a second connecting port that can be removable connected to the first connecting port.

In addition, the man-machine interface comprises an instruction-input unit and an image-output unit. However, these two units need not be simultaneously installed. Furthermore, the instruction-input unit may be integrated with the image-output unit for a touch-control display screen. The man-machine interface may further include a voice-output unit.

In brief, an acoustic-controlled camera module is set inside a portable communication device with image capturing functionality of the present invention. The portable communication device with acoustic-controlled camera module allows the user to place the portable communication device at a desired distance and not limited to only arm-length of the user, and can be acoustically activated to take picture of himself/herself or any objects remotely. Hence, the user of the portable communication device can easily take a group picture including himself/herself without the crowding and image distortion problems that occur using a conventional button-activated cellular phone camera. In other words, by setting up the acoustic-controlled camera module of the present invention in a portable communication device, the camera can be remotely activated and therefore the activation of the camera is not only limited to manual activation.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The following drawings illustrate embodiments of the invention and, together with the description, serve to explain the principles of the invention.

FIG. 1 is a block diagram showing the configuration of a portable communication device with acoustic-controlled image capturing functionality according to a first embodiment of the present invention.

FIG. 2 is a block diagram showing the configuration between the host module and the man-machine interface of the portable communication device with acoustic-controlled image capturing functionality according the first embodiment of the present invention.

FIG. 3 is a block diagram showing the configuration of a portable communication device with acoustic-controlled image capturing functionality according to a second embodiment of the present invention.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

FIG. 1 is a block diagram showing the configuration of a portable communication device with acoustic-controlled image capturing functionality according to a first embodiment of the present invention. As shown in FIG. 1, the portable communication device 100 mainly comprises a casing 110, a host module 120, a wireless communication module 130, an image-capturing unit 140, a man-machine interface 150, an acoustic-controlled camera module 160 and a voice-input unit 170.

The host module 120 is set inside the casing 110. The host module 120 may include a microprocessor, a memory and a power supply (not shown) to serve as a principal power source for functional components inside the portable communication device 100. The wireless communication module 130 is set inside the casing 110 and electrically connected to the host module 120. The wireless communication module 130 is used for transmitting and receiving wireless communication signals. The communication may be carried out by using a single protocol at a single waveband. In a more sophisticated system, the communication may be carried out automatically by switching between various communication protocols at different wavebands so that different wireless communication signals can be transmitted and received.

The image-capturing unit 140 is set on the casing 110 and is electrically connected to the host module 120 for taking still images or recording videos or moving images. The image-capturing unit 140 comprises a set of lens and an image-capturing device, for example. The acoustic-controlled camera module 160 is set within the casing 110 and is electrically connected to the host module 120. The voice-input unit 170 is set on the casing 110 and is electrically connected to the acoustic-controlled camera module 160. The voice-input unit 170 may be a microphone suitable for receiving acoustic signals from the surrounding and transferring the signals to the acoustic-controlled camera module 160. The acoustic-controlled camera module 160 is activated by the acoustic signal received by the voice-input unit 170. For example, the acoustic-controlled camera module 160 activates the image-capturing unit 140 when the waveform of the acoustic signal picked up by the voice-input unit 170 fits a preset profile or the intensity of the acoustic signal exceeds a preset value.

The voice-input unit 170 may also serve as a voice receiver when the user voice communication using the portable communication device 100. The voice-input unit 170 receives the voice produced by the user and transmits the voice signal to the host computer 120 so that voice signal can be broadcast through the wireless communication module 130. In other words, the voice receiving function of the portable communication device 100 can be provided through the voice-input unit 170.

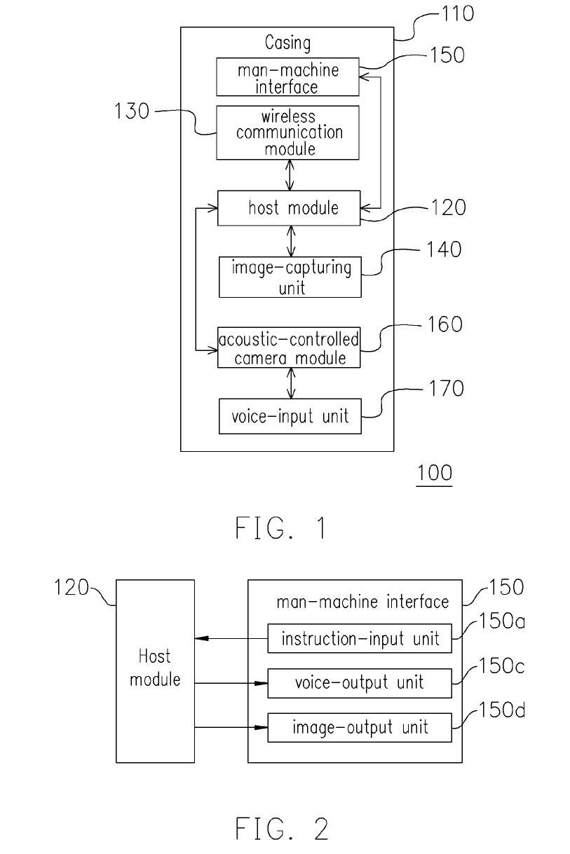

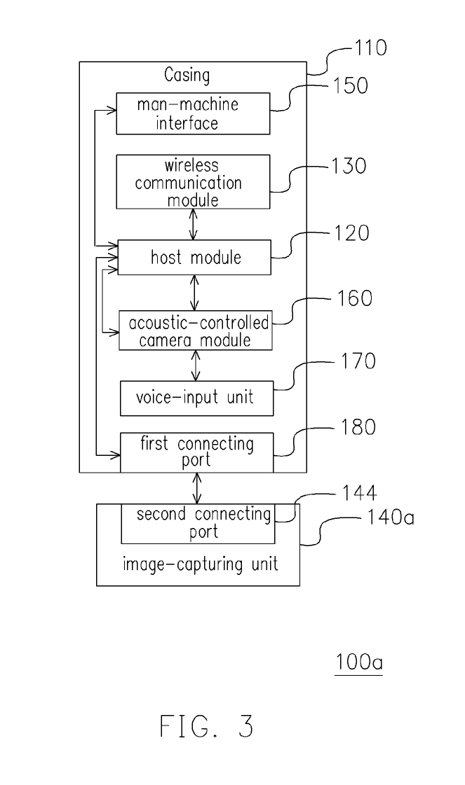

FIG. 2 is a block diagram showing the configuration between the host module and the man-machine interface of the portable communication device with acoustic-controlled image capturing functionality according a first embodiment of the present invention. As shown in FIGS. 1 and 2, the man-machine interface 150 is set on the casing 110 and is electrically connected to the host module 120 for controlling the host module 120. The man-machine interface 150 essentially comprises an instruction-input unit 150a and an image-output unit 150d. The instruction-input unit 150a may be a digital writing board or a keyboard and the image output unit 150d may be a liquid crystal display (LCD), an organic electro-luminescent display (OELD) or other flat display. Furthermore, the instruction-input unit 150a may be integrated with the image-output unit 150d for a touch-control display screen that expands the display area and facilitates input. In addition, the man-machine interface 150 may further include a voice-output unit 150c. The voice-output unit 150c is a speaker, for example.

FIG. 3 is a block diagram showing the configuration of a portable communication device with acoustic-controlled photographing function according to a second embodiment of the present invention. As shown in FIG. 3, the portable communication device 100a differs from the portable communication device 100 of the first embodiment mainly in the setting of the image-capturing unit 140a on the casing 110. In the second embodiment, the portable communication device 100a further comprises a first connecting port 180 set on the casing 110 and is electrically connected to the host module 120. The image-capturing unit 140a has a second connecting port 144 that can be removable connected to the first connecting port 180. Hence, the image-capturing unit 140a may serve as an image capturing device for taking still images or video or motion images recording center after connecting the image-capturing unit 140a to the casing 110 as an external device through the second connecting port 144 and the first connecting port 180.

In summary, the present invention provides a portable communication device with acoustic-controlled image capturing functionality for hands free remote activation in addition to the conventional press-button activation. Furthermore, with acoustic control, a group photo including the user himself can be taken at a suitable distance and not limited to only arm-length to prevent image distortion.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A portable communication device, comprising:
a casing;
a host module, set inside the casing;
a wireless communication module, set inside the casing and electrically connected to the host module for transmitting/receiving a communication signal;
an image-capturing unit, set on the casing and electrically connected to the host module for capturing an optical image of an object;
a man-machine interface, set on the casing and electrically connected to the host module for controlling the host module;
an acoustic-controlled camera module, set inside the casing and electrically connected to the host module for controlling the image-capturing unit; and
a voice-input unit, set on the casing and electrically connected to the acoustic camera module for receiving a voice message.

2. The portable communication device of claim 1, wherein the device further comprises a first connecting port set on the casing and is electrically connected to the host module, and the image-capturing unit has a second connecting port with a removable electrical connection to the first connecting port.

3. The portable communication device of claim 1, wherein the man-machine interface comprises an instruction-input unit.

4. The portable communication device of claim 1, wherein the man-machine interface comprises a voice-output unit.

5. The portable communication device of claim 1, wherein the man-machine interface comprises an image-output unit.

6. The portable communication device of claim 1, wherein the man-machine interface comprises an instruction-input unit and an image-output unit.

7. The portable communication device of claim 6, wherein the instruction-input unit is integrated with the image-output unit for a touch-control display screen.
